(19) United States
(12) Patent Application Publication
(10) Pub. No.: US 2023/0237469 A1
(43) Pub. Date: Jul. 27, 2023

(54) UTILITIES LINKED TO DIGITAL NON-FUNGIBLE ASSETS

(71) Applicant: OSOM Products, Inc., Cupertino, CA (US)

(72) Inventors: Jason Sean Gagne-Keats, Cupertino, CA (US); Gary Anderson, San Mateo, CA (US); Wolfgang Wesley Muller, San Francisco, CA (US); Jean-Baptiste Charles Theou, Sene (FR)

(21) Appl. No.: 18/159,067

(22) Filed: Jan. 24, 2023

Related U.S. Application Data
(60) Provisional application No. 63/267,085, filed on Jan. 24, 2022.

(51) Int. Cl. G06Q 20/36; G06Q 20/38

(52) U.S. Cl. CPC G06Q 20/3672; G06Q 20/3825; G06Q 20/3829; G06Q 20/389

(57) ABSTRACT

A technique for linking utilities with non-fungible tokens (NFTs) is disclosed. The utilities are not necessarily physical assets. For example, the utilities can be services or functions that depend on who and when the NFT is owned. The utilities can be enabled on or through a device or computer system. The utilities can have levels or be of different types and vary by time. For example, a utility can change, aggregate, or expire over time.

### CROSS REFERENCE TO RELATED APPLICATIONS

This application claims the benefit of U.S. Provisional Application No. 63/267,085, filed Jan. 24, 2022. The aforementioned application is incorporated herein by reference in its entirety for all purposes.

### TECHNICAL FIELD

The disclosed teachings generally relate to linking utilities to digital non-fungible assets.

### BACKGROUND

A non-fungible token (NFT) is a non-interchangeable unit of data stored on a blockchain, a form of digital ledger. Types of NFT data units include digital files such as photos, videos, and audio. Because each token is uniquely identifiable, NFTs differ from blockchain cryptocurrencies, such as Bitcoin. NFT ledgers can provide a public certificate of authenticity or proof of ownership.

### BRIEF DESCRIPTION OF THE DRAWINGS

Detailed descriptions of implementations of the present invention will be described and explained through the use of the accompanying drawings.

FIG. 1 is a block diagram that illustrates a blockchain including a network of peer nodes that can store non-fungible tokens (NFTs).

FIG. 2 is a block diagram that illustrates a system that can manage utilities linked to digital and/or physical non-fungible objects.

FIG. 3 is a flowchart that illustrates a method for managing utilities linked to digital and/or physical non-fungible objects.

FIG. 4 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a technique for linking utilities with unique digital assets (e.g., non-fungible tokens (NFTs)). The utilities are not necessarily physical non-fungible assets. For example, the utilities can be services or functions that depend on who and when the NFT is owned. The utilities can be enabled on or through a device or computer system. The utilities can have levels/tiers or be of different types and vary by time. For example, a utility can change, aggregate, or expire over time. Examples of utilities include functions, services, tracking or monitoring activity.

The utilities can include functions or services that are available to an owner of the NFT or the person possessing the NFT (e.g., when stored on a smartphone). For example, an owner of the NFT can be granted a subscription to a video streaming service, a cloud storage service, or some other services or functions. For example, the owner of the NFT can submit identifying information and submit the NFT to a website, which verifies the submission to activate access to a computer resource. A user ID and passcode can then be issued for the owner to access the resource from any device. The NFT can be transferred to another owner, who can then gain access to the same resource or another resource that is associated with the NFT.

In an example where an NFT is linked to a particular device, access to a utility is made available on or through the device. For example, the NFT can be linked to a smartphone by using the smartphone's unique IMEI (International Mobile Equipment Identity) number. The NFT can be stored on a blockchain to prove ownership of the smartphone prior to and after delivery to an owner. The NFT can enable certain utilities of the smartphone depending on who and when the NFT is owned or in possession. In one example, a first owner of the smartphone can use the NFT to add cloud storage for the smartphone. When the smartphone is transferred to another owner, the NFT allows the new owner to activate the cloud storage for the smartphone by submitting the NFT to the service provider.

The NFT may be generated using a unique identifier corresponding to the device, e.g., an IMEI (International Mobile Equipment Identity) number. The NFT may be assigned to a cryptographic address of a cryptography-based storage application. The NFT may contain data fields such as an owner address, indicating the cryptography-based storage application; additionally, the NFT may be associated with metadata. Such metadata (e.g., stored in a metadata dataset) can include privilege parameters, each of which describe a utility or service applied to the device. Privilege parameters may describe the extent of utilities or services granted (e.g., the maximum bandwidth of mobile data, the length of a warranty, the bytes of storage allotted for data backup in the cloud, etc.) and a list of devices to which the utilities or services may be applied.

The utilities linked to an NFT can be time dependent (e.g., enabled or disabled based on time). For example, a first utility can be enabled when an NFT is newly issued and disabled when the NFT reaches a threshold age. A second utility can be enabled at the threshold age. In another example, utilities are operable according to a schedule and by an owner of the NFT. For example, the NFT can be used as an authentication factor only Monday through Friday, and not during Saturday or Sunday. The utilities can include authentication, identification, or services that are available to the owner of the NFT but are device independent. In another example, where the NFT is linked to a device, the utilities can be provided only on the device and nowhere else. For example, utilities on a linked phone can be made available only on or through the phone. Hence, an owner of the NFT can be enabled to access software or functions only on the phone during scheduled times.

The utilities linked to an NFT can be owner dependent (e.g., enabled or disabled based on the owner's identify). For example, a utility can be enabled for the first owner of an NFT and a different utility can be enabled for a subsequent owner of the same NFT. As such, the quantity or type of utilities can vary to induce either transferring the NFT or keeping the NFT. For example, a newly issued NFT can have numerous associated utilities. The number of utilities can decrease with every transfer. As such, the NFT would incentivize the initial owner to keep the NFT. In another example, the number of utilities available to an owner of an NFT can increase with every transfer thereby inducing transfer of the NFT. The value of an NFT can also vary over time depending on the utilities that are made available by the NFT. For example, the value of an NFT can decrease as more utilities decrease or the value of the NFT can increase as more utilities increase.

As used herein, an NFT is a unit of data that can be stored on a digital ledger (e.g., a blockchain), and the NFT can be sold and traded. The NFT can be associated with a particular digital or physical asset (such as a file) and a license to use the asset for a specified purpose. An NFT (and, if applicable, the associated license to an underlying asset) can be traded and sold on secondary digital markets. Hence, NFT trading can result in an exchange of ownership of an underlying asset.

NFTs function like cryptographic tokens, but, unlike cryptocurrencies such as Bitcoin or Ethereum, NFTs are not mutually interchangeable, hence not fungible. While all bitcoins are equal, each NFT may represent a different underlying asset and thus may have a different value. NFTs are created when blockchains string records of cryptographic hash (a set of characters identifying a set of data) onto records therefore creating a chain of identifiable data blocks. This cryptographic transaction process ensures the authentication of each digital file by providing a digital signature that is used to track NFT ownership.

The NFT can represent a utility initially decoupled from an owner. Whoever owns the NFT will have to register the NFT on a utility website to access the utility. A benefit of this method is that the NFT can enable utilities that are transferrable and do not require that a user register with the utility provider. Moreover, the utilities associated with an NFT can vary or vary among similar NFTs. For example, every 100th NFT sold by a utility service provider can trigger a redeemable gift. The NFT can be associated with time snapshots that are thresholds for enabling utilities before or after the snapshots or allow for redeeming goods relative to the snapshots.

The blockchain can store NFTs and associated transactions in records, copies of which are distributed and maintained among nodes of a computer network. The entries are stored in blocks of the distributed ledger that are cryptographically related. A public blockchain is a common example of a distributed ledger that can record data or transactions between parties in a verifiable and permanent way. Specifically, a blockchain system has a decentralized, distributed database where a ledger is maintained by peer nodes. Hence, an intermediary is not required to maintain a blockchain. The data are typically authenticated with cryptographic hashing and mining techniques.

The blockchain is analogous to a distributed database on a distributed computing system that maintains a continuously growing list of ordered records called blocks. A block of a blockchain includes records of transaction(s) or other recorded data (e.g., condition data). Each block contains at least one timestamp, and a block links to a previous block to thus form a chain of blocks. Blockchains are inherently resistant to modification of their recorded data. That is, once recorded, the data in a block cannot be altered retroactively. Through a peer network and distributed timestamping, a blockchain is managed in an autonomous manner.

Decentralized consensus can be achieved with a blockchain. This makes blockchains suitable for recording NFTs, events, conditions, other records management activities, identity management, transaction processing, and proving data provenance. Examples of decentralized systems that implement blockchains include Bitcoin, Ethereum, and Solana. These types of systems provide a pragmatic solution for arriving at a consensus in the face of trust and timing problems typically encountered in distributed networks.

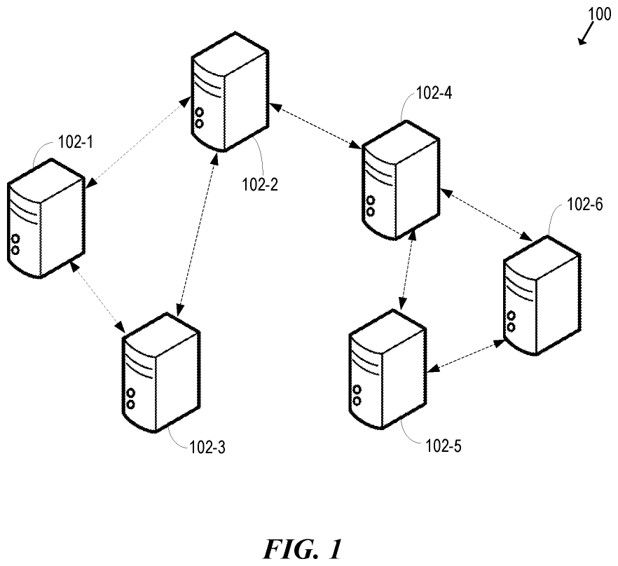

FIG. 1 illustrates a network 100 of interconnected peer nodes 102-1 through 102-6 (also referred to collectively as peer nodes 102 and individually as peer node 102). The peer nodes 102 can be distributed across various geographic locations including regions all over the world. The network 100 can include a combination of private, public, wired, or wireless portions. Data communicated over the network 100 can be encrypted or unencrypted at various locations or portions of the network 100. Each peer node 102 can include combinations of hardware and/or software to process data, perform functions, communicate over the network 100, and the like.

The peer nodes 102 can include computing devices such as servers, desktop or laptop computers, handheld mobile devices, and other electronic devices. Any component of the network 100 can include a processor, memory or storage, a network transceiver, a display, operating system, and application software (e.g., for providing a user interface), and the like. Other components, hardware, and/or software included in the network 100 that are known to persons skilled in the art are not shown or discussed herein for the sake of brevity.

The network 100 can implement a blockchain that allows for the secure management of a shared ledger, where NFTs are verified and stored on the network 100 without a governing central authority. Blockchains can be implemented in different configurations, ranging from public, open-source networks, to private blockchains that require explicit permission to read or write transactions. Central to a blockchain are cryptographic hash functions that secure the network 100, in addition to enabling transactions, to protect a blockchain's integrity and anonymity.

The network 100 can utilize cryptography to securely process data. For example, public-key cryptography uses asymmetric key algorithms, where a key used by one party to perform either encryption or decryption is not the same as the key used by another in the counterpart operation. Each party has a pair of cryptographic keys: a public encryption key and a private decryption key. For example, a key pair used for digital signatures consists of a private signing key and a public verification key. The public key can be widely distributed, while the private key is known only to its proprietor. The keys are related mathematically, but the parameters are chosen so that calculating the private key from the public key is unfeasible. Moreover, the keys could be expressed in various formats, including hexadecimal format.

Blockchain operations, which comprise many requests for service in the systems and methods described herein, may be signed with cryptographic signatures. A cryptographic signature may be generated using a private key of a cryptography-based storage application in a user's control. The cryptographic signature may be verified by a blockchain node in the blockchain using the public key of the same cryptography-based storage application corresponding to the user. As referenced herein, blockchain operation functionality may include any functionality specific to a blockchain, such as functionality for performing blockchain transactions (e.g., generating cryptographic tokens, transferring those tokens, etc.).

For example, a function (e.g., Rivest-Shamir-Adleman (RSA) function) can be applied to a message (or the hash of a message) with the private key of the cryptography-based storage application belonging to the sender. A node of the blockchain may verify that the request is coming from the cryptography-based storage application by applying a function with the public key to the digital signature and comparing the result to the expected message (or the hash of the message). If the expected message and/or hash matches the result of applying the function, then the authentication system can verify that the request is coming from the cryptography-based storage application associated with the private and public keys. Thus, the authentication system can ensure that the cryptographic signature originated from the user that controls the cryptography-based storage application. Proof that the user controls the private key of the cryptographic address is proof that the cryptographic token has been assigned to authenticate the user. Any suitable functions and/or alternative digital signature schemes may be used, such as Probabilistic Signature Scheme (PSS) and/or the like.

As such, the blockchain storing the NFT can be used as proof of ownership of a utility. In one example, cross-chain compatibility is enabled to transfer NFT-related data across different blockchains. For example, a personal digital wallet can hold the NFT, which does not need to be tied to a specific ecosystem (e.g., Solana). Instead, the disclosed technology is blockchain agnostic such that NFT-related data (e.g., a smart contract associated with an NFT transaction) can be transferred across different blockchains.

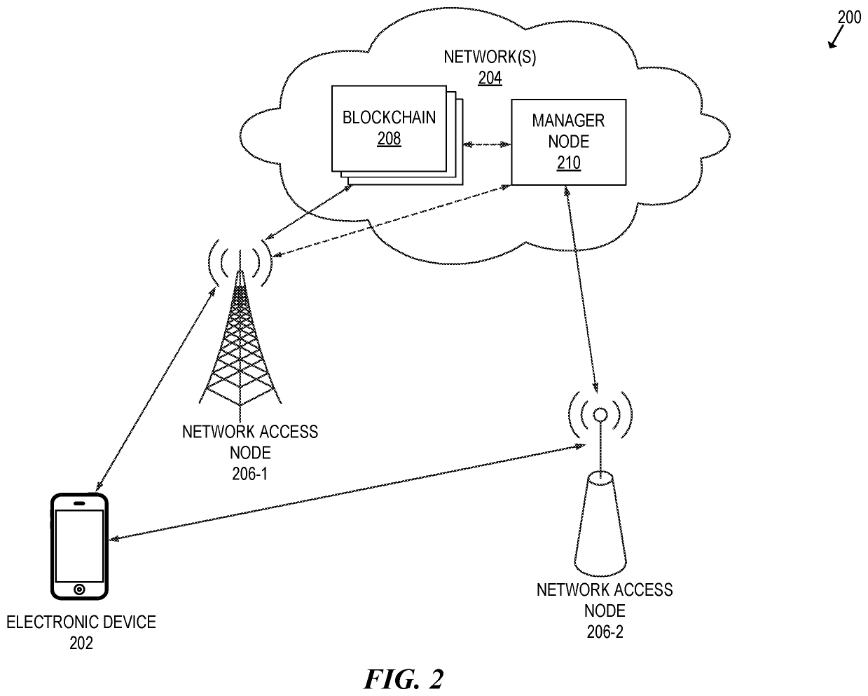

FIG. 2 is a block diagram that illustrates a system that can manage NFTs linked to non-fungible electronic devices associated with one or more utilities. The system 200 includes an electronic device 202 that is communicatively coupled to one or more networks 204 via network access nodes 206-1 and 206-2 (referred to collectively as network access nodes 206).

The electronic device 202 can be any type of electronic device that can communicate wirelessly with a network node and/or with another electronic device in a cellular, computer, and/or mobile communications system. Examples of the electronic device 202 include smartphones, tablet computers, wireless devices capable of machine-to-machine (M2M) communication, wearable electronic devices, Internet of Things devices (IoT devices), and any other handheld device that is capable of accessing the network(s) 204. Although only one electronic device 202 is illustrated in FIG. 2, the disclosed embodiments can include any number of electronic devices.

The electronic device 202 can store and transmit (e.g., internally and/or with other electronic devices over a network) code (composed of software instructions) and data using machine-readable media, such as non-transitory machine-readable media (e.g., machine-readable storage media such as magnetic disks, optical disks, read-only memory (ROM), flash memory devices, and phase change memory) and transitory machine-readable transmission media (e.g., electrical, optical, acoustic, or other forms of propagated signals, such as carrier waves or infrared signals).

The electronic device 202 can include hardware such as one or more processors coupled to sensors and a non-transitory machine-readable media to store code and/or sensor data, user input/output (I/O) devices (e.g., a keyboard, a touchscreen, and/or a display), and network connections (e.g., an antenna) to transmit code and/or data using propagating signals. The coupling of the processor(s) and other components is typically through one or more busses and bridges (also referred to as bus controllers). Thus, a non-transitory machine-readable medium of a given electronic device typically stores instructions for execution on a processor(s) of that electronic device. One or more parts of an embodiment of the present disclosure can be implemented using different combinations of software, firmware, and/or hardware.

The network access nodes 206 can be any type of radio network node that can communicate with a wireless device (e.g., electronic device 202) and/or with another network node. The network access nodes 206 can be a network device or apparatus. Examples of network access nodes include a base station (e.g., network access node 206-1), an access point (e.g., network access node 206-2), or any other type of network node such as a network controller, radio network controller (RNC), base station controller (BSC), a relay, transmission points, and the like.

The system 200 depicts different types of wireless access nodes 206 to illustrate that the electronic device 202 can access different types of networks through different types of network access nodes. For example, a base station (e.g., the network access node 206-1) can provide access to a cellular telecommunications system of the network(s) 204. An access point (e.g., the network access node 206-2) is a transceiver that provides access to a computer system of the network(s) 204.

The network(s) 204 can include any combination of private, public, wired, or wireless systems such as a cellular network, a computer network, the Internet, and the like. Any data communicated over the network(s) 204 can be encrypted or unencrypted at various locations or along different portions of the networks. Examples of wireless systems include Wideband Code Division Multiple Access (WCDMA), High Speed Packet Access (HSPA), Wi-Fi, Wireless Local Area Network (WLAN), and Global System for Mobile Communications (GSM), GSM Enhanced Data Rates for Global Evolution (EDGE) Radio Access Network (GERAN), 4G or 5G wireless wide area networks (WWAN), and other systems that can also benefit from exploiting the scope of this disclosure.

The system 200 includes a blockchain 208 that stores non-fungible data (e.g., NFTs) linked to the electronic device 202 and communicated to the blockchain 208 via the network access nodes 206. The blockchain 208 is distributed over a combination of network nodes (e.g., peer nodes 102) that store NFTs and related data across other network nodes of a peer-to-peer network. The network nodes of the blockchain 208 can each replicate and store an identical copy of the condition data and update independently. Although shown in the network(s) 204, the blockchain 208 can be located anywhere to maintain a tamper-proof copy of NFT-related data.

The system 200 includes a manager node 210 that can mediate the flow of NFTs and related data on the blockchain 208 and linked to the electronic device 202. In some embodiments, the manager node 210 can include any number of server computers communicatively coupled to the electronic device 202 via the network access nodes 206. The manager node 210 can include combinations of hardware and/or software to process condition data, perform functions, communicate over the network(s) 204, etc. For example, server computers of the manager node 210 can include a processor, memory or storage, a transceiver, a display, operating system and application software, and the like. Other components, hardware, and/or software included in the system 200 that are well known to persons skilled in the art are not shown or discussed herein for brevity. Moreover, although shown as being included in the network(s) 204, the manager node 210 can be located anywhere in the system 200 to implement the disclosed technology.

The manager node 210 can track a current owner of the electronic device 202 or utility based on a linked NFT. The manager node 210 can also control which types of utilities are available based on ownership of the associated NFT or certain criteria. In some embodiments, NFT-related data could have values that depend on the age of the NFT and owner of the electronic device 202.

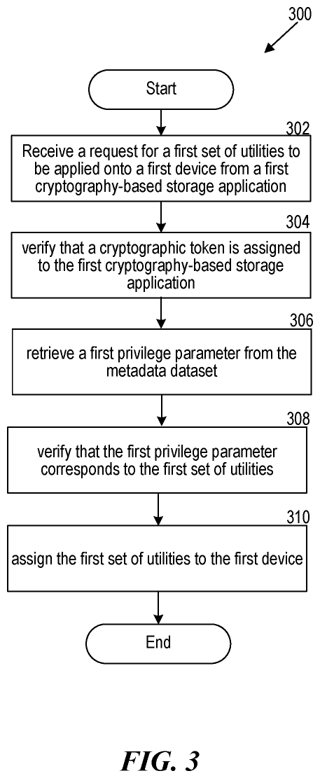

FIG. 3 is a flowchart that illustrates a method for linking a digital non-fungible asset with a utility. At 302, the system receives, from a first cryptography-based storage application, a request for a first set of utilities to be applied onto a first device. At 304, verifies that a cryptographic token (the NFT) is assigned to the first cryptography-based storage application. The NFT can be stored on the blockchain as public evidence of ownership of the utility (or stored on a device). In one example, accompanying data (e.g., metadata) can be stored along with the NFT on the blockchain. The NFT-related data (NFT and metadata) enables tracking of the utility by a utility provider. Specifically, the NFT may be associated with a metadata dataset consisting of privilege parameters. At 306, the system retrieves a first privilege parameter from the metadata dataset. At 308, the system verifies that the first privilege parameter corresponds to the first set of utilities. At 310, the system assigns the first set of utilities to the first device.

The NFT may be generated using an IMEI number. The NFT may be assigned to a cryptographic address of a cryptography-based storage application. The NFT may be associated with metadata. Such metadata (e.g., stored in a metadata dataset) may consist of privilege parameters, each of which describe a utility or service applied to the device. Privilege parameters may describe the extent of utilities or services granted using a feature vector. Privilege parameters may also contain a list of devices to which the utilities or services may be applied, and expiration parameters for a particular utility or service where applicable.

In response to a request for accessing a utility, the system may determine that the utility is covered by the set of privilege parameters assigned to the NFT. The system may compare a time of the request for a first set of utilities to the expiration parameter of the first privilege parameter and compare the nature and extent of the first set of utilities to the feature vector of the first privilege parameter to make sure the request for utility is valid and of an appropriate amount. Additionally, the system may verify that a device identifier for the device is on the list of device identifiers of the first privilege parameter. Certain utilities and services may be restricted to specific devices.

In some embodiments, the system may adjust the privilege parameters in the metadata dataset of an NFT per a user's request. For example, the user may purchase additional bandwidth for mobile data. In another example, they may decide that their streaming subscription is no longer needed, and cancel the subscription to avoid further fees. In such situations, the system may receive from the first cryptography-based storage application a request for a second set of utilities. The request may contain a second privilege parameter, which differs from the first privilege parameter in the feature vector, the expiration parameter or the list of device identifiers. In this way, a user can request extension of a service or utility beyond its original expiration date, or provide the service or utility to an alternative device. The second privilege parameter may contain an expiration parameter later than that of the first, or the list of devices may contain additional devices. In some embodiments, the system may verify that an appropriate payment has been made in association with the request for extension of service.

An example utility enabled by the NFT is using the NFT as an authentication factor. For example, a cryptography-based storage application may be located on a smartphone associated with the NFT. A login attempt for the smartphone can involve receiving a login request for accessing the smartphone, containing an address associated with the cryptography-based storage application, and a cryptographic signature generated using a private key of the first cryptography-based storage application. The blockchain may use the private key to verify the validity of the cryptographic signature and grant the login request. In this way, the NFT not only symbolizes the right to access the smartphone, the NFT provides the utility of cryptographic security and confidentiality. In addition to unlocking a smartphone itself, the NFT may be used as an authentication factor for applications on the smartphone (e.g., streaming platforms) using the same process as above.

The NFT can operate as a tradable asset to grant access to a resource, or the resource can be made available to the owner of the NFT at a particular time. The linkage between the digital non-fungible asset and utility can optionally act as an authentication factor. That is, the NFT can act as one of multiple authentication factors used for conducting a transaction to purchase or sell goods. In one example, the NFT acts as an authentication mechanism that enables the owner to sell the NFT in a secondary market. As such, the NFT comes with an accompanying utility, which can vary. Further, the NFT can increase in value, and be used to buy a second device (the NFT is then tied to the second device). To execute a trade of the NFT, the system may transfer it from a first cryptographic address of a first cryptography-based storage application to a second cryptographic address of a second cryptography-based storage application. For example, the system may receive, from the first cryptography-based storage application, a request for transference of the first cryptographic token. The request for transference indicates a destination cryptographic address corresponding to a second cryptography-based storage application. The system may then use a blockchain operation to verify that the NFT is, in fact, still assigned to the first cryptography-based storage application. After confirming that the NFT is assigned to the first cryptography-based storage application and that the request for transference is signed with a valid signature of the first cryptography-based storage application, the system may assign the first cryptographic token to the second cryptography-based storage application at the destination cryptographic address. Thus the NFT, with its associated utilities and services, are transferred to a second user.

In some embodiments, the system may remove privilege parameters from an NFT, for example to remove a utility or service for violation of terms. To deny a first set of utilities from a first cryptography-based storage application, the system may remove a first privilege parameter from the metadata dataset, the first privilege corresponding to the first set of utilities.

Although examples described herein refer to linking a smartphone or other non-fungible electronic device to an NFT, the disclosed technology is not so limited. Instead, the technology contemplates linking digital non-fungible assets as proof of ownership over any physical object that is uniquely identifiable, particularly among other physical objects of the same kind or type and using a unique identifier. Examples include a vehicle identification number (VIN) of an automobile or a parcel number or physical address for real property. As such, the NFT or other unique digital asset can represent ownership over the unique physical asset. A utility can be enabled or disabled for the physical object associated with the NFT.

The technology also relates to a technique for selling the rights to a utility without need to identify the owner of the utility thereby maintaining privacy for the owners. The NFT thus operates as a proof or evidence of the purchase (e.g., receipt) without necessarily identify the person who has access to the utility. The NFT can be timestamped for the date of purchase or for a date that triggers certain rights over the physical object. For example, an NFT for a particular phone can be associated with a future date such that the owner of the NFT at that date will be granted rights to the physical asset via the NFT. As such, the NFT can be stored on a blockchain with accompanying metadata that is used to, for example, track services, historical data, or other status data for the physical asset.

Computer System

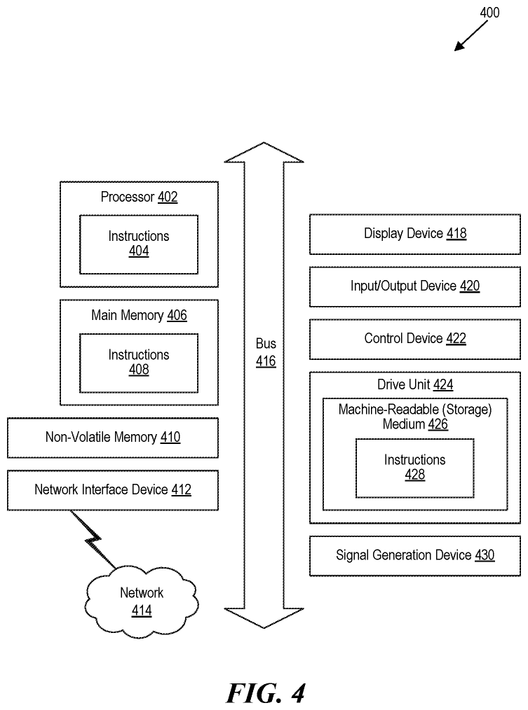

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, video display device 418, an input/output device 420, a control device 422 (e.g., keyboard and pointing device), a drive unit 424 that includes a storage medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in this specification can be implemented.

The computer system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 400. In some implementation, the computer system 400 can be an embedded computer system, a system-on-chip (SOC), a single-board computer system (SBC) or a distributed system such as a mesh of computer systems or include one or more cloud components in one or more networks. Where appropriate, one or more computer systems 400 can perform operations in real-time, near real-time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable (storage) medium 426 can include any medium that is capable of storing, encoding, or carrying a set of instructions for execution by the computing system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### REMARKS

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

What is claimed is:

1. A system for enabling utilities using non-fungible tokens, the system comprising:
a processor; and
a memory storing instructions that, when executed by the processor, cause the system to:
receive, from a first computing device, a first request for bandwidth resources for the first computing device,
wherein the first request comprises an address associated with a first cryptography-based storage application and a cryptographic signature generated using a private key of the first cryptography-based storage application;
determine, using the cryptographic signature, that the first cryptography-based storage application controls a first cryptographic token;
retrieve, using a blockchain operation, a link to a metadata database associated with the first cryptographic token;
using the link to the metadata database, retrieve a first set of privilege parameters;
compare the first set of privilege parameters with the bandwidth resources of the first request;
in response to determining that the first set of privilege parameters are satisfied for the bandwidth resources of the first request, allocate to the first computing device the bandwidth resources of the first request.

2. A method for enabling utilities using non-fungible tokens, the method comprising:
receiving, from a first cryptography-based storage application, a request for a first set of utilities to be applied onto a first device;
verifying that a cryptographic token is assigned to the first cryptography-based storage application,
wherein the cryptographic token is associated with a metadata dataset;
retrieving a first privilege parameter from the metadata dataset;
verifying that the first privilege parameter corresponds to the first set of utilities; and
assigning the first set of utilities to the first device.

3. The method of claim 2, wherein the metadata dataset comprises a plurality of privilege parameters, a privilege parameter comprising:
a feature vector describing an extent and nature of a utility associated with the privilege parameter;
an expiration parameter indicating a time period until the utility expires; and
a list of device identifiers,
wherein each device identifier is associated with a device to which the utility is applied.

4. The method of claim 2, wherein the cryptographic token authenticates login requests at the first device, the method further comprising:
receiving a login request for accessing the first device, comprising an address associated with the first cryptography-based storage application, and a cryptographic signature generated using a private key of the first cryptography-based storage application;
determining, using the cryptographic signature, that the first cryptography-based storage application controls the cryptographic token; and
granting access to the first device responsive to the login request.

5. The method of claim 2, wherein verifying that the first privilege parameter corresponds to the first set of utilities comprises:
comparing a time of the request for a first set of utilities to the expiration parameter of the first privilege parameter;
comparing the nature and extent of the first set of utilities to the feature vector of the first privilege parameter;
verifying that a device identifier for the first device is on the list of device identifiers of the first privilege parameter.

6. The method of claim 2, wherein the cryptographic token enables extension of the first set of utilities to a second device, the method further comprising:
receiving, from the first cryptography-based storage application, a request for extension of the first set of utilities to a second device,
wherein the request for extension comprises a second device identifier for the second device;
obtaining permission to modify the metadata dataset that is associated with the cryptographic token;
modifying the first privilege parameter to add the second device identifier to the first permission parameter.

7. The method of claim 2, wherein the cryptographic token enables addition of a second set of utilities, the method further comprising:
receiving, from the first cryptography-based storage application, a request for a second set of utilities,
wherein the request for the second set of utilities comprises a second privilege parameter,
wherein the second privilege parameter comprises a feature vector, an expiration parameter and a list of device identifiers;
obtaining permission to modify the metadata dataset the cryptographic token is associated with;
adding the second privilege parameter to the metadata dataset.

8. The method of claim 2, wherein the first cryptography-based storage application is stored on the first device.

9. The method of claim 2 further comprising:
receiving, from the first cryptography-based storage application, a request for transference of the cryptographic token,
wherein the request for transference indicates a destination cryptographic address corresponding to a second cryptography-based storage application;
using a blockchain operation, verifying that the cryptographic token is assigned to the first cryptography-based storage application; and
assigning the cryptographic token to the second cryptography-based storage application at the destination cryptographic address.

10. The method of claim 2 further comprising:
determining to deny the first set of utilities from the first cryptography-based storage application;
obtaining permission to modify the metadata dataset the cryptographic token is associated with;
removing the first privilege parameter from the metadata dataset.

11. The method of claim 2, wherein the cryptographic token includes a non-fungible token generated using an identifier of the metadata dataset.

12. A non-transitory computer-readable medium storing instructions that, when executed by one or more processors, cause the one or more processors to perform operations comprising:
receiving, from a first cryptography-based storage application, a request for a first set of utilities to be applied onto a first device;
verifying that a cryptographic token is assigned to the first cryptography-based storage application, wherein the cryptographic token is associated with a metadata dataset;
retrieving a first privilege parameter from the metadata dataset;
verifying that the first privilege parameter corresponds to the first set of utilities; and
assigning the first set of utilities to the first device.

13. The non-transitory computer-readable medium of claim 12, wherein the metadata dataset comprises a plurality of privilege parameters, a privilege parameter comprising:
a feature vector describing an extent and nature of a utility associated with the privilege parameter;
an expiration parameter indicating a time period until the utility expires; and
a list of device identifiers, wherein each device identifier is associated with a device to which the utility is applied.

14. The non-transitory computer-readable medium of claim 12, wherein the cryptographic token authenticates login requests at the first device, the operations further comprising:
receiving a login request for accessing the first device, comprising an address associated with the first cryptography-based storage application, and a cryptographic signature generated using a private key of the first cryptography-based storage application;
determining, using the cryptographic signature, that the first cryptography-based storage application controls the cryptographic token; and
granting access to the first device responsive to the login request.

15. The non-transitory computer-readable medium of claim 12, wherein verifying that the first privilege parameter corresponds to the first set of utilities comprises:
comparing a time of the request for a first set of utilities to the expiration parameter of the first privilege parameter;
comparing the nature and extent of the first set of utilities to the feature vector of the first privilege parameter;
verifying that a device identifier for the first device is on the list of device identifiers of the first privilege parameter.

16. The non-transitory computer-readable medium of claim 12, wherein the cryptographic token enables extension of the first set of utilities to a second device, the operations further comprising:
receiving, from the first cryptography-based storage application, a request for extension of the first set of utilities to a second device,
wherein the request for extension comprises a second device identifier for the second device;
obtaining permission to modify the metadata dataset the cryptographic token is associated with;
modifying the first privilege parameter to add the second device identifier to the first permission parameter.

17. The non-transitory computer-readable medium of claim 12, wherein the cryptographic token enables addition of a second set of utilities, the operations further comprising:
receiving, from the first cryptography-based storage application, a request for a second set of utilities,
wherein the request for the second set of utilities comprises a second privilege parameter,
wherein the second privilege parameter comprises a feature vector, an expiration parameter and a list of device identifiers;
obtaining permission to modify the metadata dataset the cryptographic token is associated with;
adding the second privilege parameter to the metadata dataset.

18. The non-transitory computer-readable medium of claim 12, wherein the first cryptography-based storage application is stored on the first device.

19. The non-transitory computer-readable medium of claim 12, the operations further comprising:
receiving, from the first cryptography-based storage application, a request for transference of the cryptographic token,
wherein the request for transference indicates a destination cryptographic address corresponding to a second cryptography-based storage application;
using a blockchain operation, verifying that the cryptographic token is assigned to the first cryptography-based storage application; and
assigning the cryptographic token to the second cryptography-based storage application at the destination cryptographic address.

20. The non-transitory computer-readable medium of claim 12, the operations further comprising:
determining to deny the first set of utilities from the first cryptography-based storage application;
obtaining permission to modify the metadata dataset the cryptographic token is associated with;
removing the first privilege parameter from the metadata dataset.

21. A method for enabling utilities with digital non-fungible assets, the method comprising:
linking one or more utilities to a non-fungible token (NFT),
wherein the utility includes a service or resource available to an owner of the NFT, and
storing the NFT and accompanying metadata indicative of one or more utilities on
a blockchain thereby creating a public record of the one or more utilities linked to the NFT; and
enabling the one or more utilities based on proof of ownership of the NFT or the accompanying metadata on the blockchain.

22. The method of claim 21, wherein the one or more utilities are device agnostic.

23. The method of claim 21, wherein the NFT is linked to a non-fungible device, and wherein the one or more utilities are only available on or through the non-fungible device.

24. The method of claim 21, wherein the one or more utilities are accessible to an owner of the NFT without needing to identify the owner.
